(19) United States
(12) Patent Application Publication
(10) Pub. No.: US 2022/0387978 A1
(43) Pub. Date: Dec. 8, 2022

(54) HYDROGENATED TIO2 DENITRATION CATALYST, PREPARATION METHOD THEREFOR AND APPLICATION THEREOF

(71) Applicants: CHINA ENERGY INVESTMENT CORPORATION LIMITED, Beijing (CN); NATIONAL INSTITUTE OF CLEAN-AND-LOW-CARBON ENERGY, Beijing (CN)

(72) Inventors: Baodong WANG, Beijing (CN); Ge LI, Beijing (CN); Ziran MA, Beijing (CN); Hongyan WANG, Beijing (CN); Chunlin ZHAO, Beijing (CN); Jiali ZHOU, Beijing (CN)

(21) Appl. No.: 17/773,719

(22) PCT Filed: Mar. 3, 2020
(86) PCT No.: PCT/CN2020/077524

§ 371 Date: May 2, 2022

(30) Foreign Application Priority Data
Nov. 4, 2019 (CN) 201911066223.7

(51) Int. Cl. B01J 27/18; B01J 37/08; B01J 37/18; B01J 35/10; B01D 53/86

(52) U.S. Cl. CPC B01J 27/18; B01J 37/082; B01J 37/18; B01J 35/1019; B01J 35/1038; B01J 35/1061; B01D 53/8628; B01D 2255/20707; B01D 2255/9207; B01D 2255/9202

(57) ABSTRACT

The present invention relates to the technical field of flue gas denitration catalysts, and discloses a hydrogenated TiO₂ denitration catalyst and a preparation method and use thereof. The hydrogenated TiO₂ denitration catalyst has a crystal form of anatase form, with oxygen vacancies and surface hydroxyl groups; wherein the hydrogenated TiO₂ denitration catalyst contains TiO₂, SO₃ and P₂O₅, and based on the total weight of the hydrogenated TiO₂ denitration catalyst, the content of TiO₂ is 98-99.8% by weight, the content of SO₃ is 0.2-1% by weight, and the content of P₂O₅ is 0.1-0.2% by weight. The hydrogenated TiO₂ denitration catalyst has high denitration activity at 300-400° C. and N₂ selectivity as high as 85% or more, and can be used in NH₃—SCR denitration.

### FIELD OF THE INVENTION

The invention relates to the technical field of flue gas denitration catalysts, in particular to a hydrogenated TiO₂ denitration catalyst and preparation methods and use thereof.

### BACKGROUND OF THE INVENTION

Coal-fired power plants are one of the main emission sources of NON, and nitrogen oxides (NOₓ), including NO, NO₂, and N₂O, are one of the main air pollutants. The NOₓ emitted is dominated by NO, and NO is easily oxidized to NO₂ after diffusing into the atmosphere, and NO₂ is one of the main factors affecting the quality of the atmospheric environment.

The methods for removing NOₓ mainly include wet denitration and dry denitration. Dry denitration technology includes three categories: the first is selective catalytic reduction, selective non-catalytic reduction and hot carbon reduction; the second is electron beam irradiation and pulsed corona plasma; the third is plasma decomposition at low temperature and atmospheric pressure. The latter two methods are still in the experimental research stage. In the Selective Catalytic Reduction (SCR), ammonia is used as a reducing agent and sprayed into the flue gas at a temperature of about 300-420° C., under the action of the catalyst, NOₓ is selectively reduced to N₂ and H₂O, instead of being oxidized by O₂. NH₃—SCR has a denitration efficiency of more than 90%, which is the most mature technology with the highest denitrification efficiency among various denitration technologies, and has become the mainstream technology of denitration in power plants at home and abroad. Catalyst is the core of SCR denitration technology. Since the 1970s, four types of commercial catalysts have been developed abroad, namely noble metal catalysts, metal oxide catalysts, molecular sieve catalysts and activated carbon catalysts.

At present, the catalyst widely used to remove NOₓ emitted from stationary sources such as coal-fired power plants is V₂O₅—WO₃—TiO₂ catalyst, and its optimum activity temperature range is 350-450° C. Wherein, V₂O₅ is the main active component, WO₃ is the active assistant, and TiO₂ is the carrier. V₂O₅ is highly toxic and expensive, so it is imperative to find a new vanadium-free and environment-friendly denitration catalyst. In recent years, scholars at home and abroad have used transition metals (Mn, Cu, Fe, Ce, etc.) or noble metals (Pt, Pd, Au, etc.) as active components to prepare a series of denitration catalysts with different temperature ranges.

However, so far, there has been no research on denitration catalysts without active components.

### SUMMARY OF THE INVENTION

The object of the present invention is to overcome the defects that all the existing SCR denitration catalysts in the prior art require active components and have high cost, and to provide a hydrogenated TiO₂ denitration catalyst and preparation method and use thereof, and the hydrogenated TiO₂ denitration catalyst has high denitration activity.

In order to achieve the above object, the first aspect of the present invention provides a hydrogenated TiO₂ denitration catalyst, wherein the hydrogenated TiO₂ denitration catalyst has a crystal form of anatase form, with oxygen vacancies and surface hydroxyl groups Ti—OH, and the hydrogenated TiO₂ denitration catalyst contains TiO₂, SO₃ and P₂O₅, and based on the total weight of the hydrogenated TiO₂ denitration catalyst, the content of TiO₂ is 98-99.8% by weight, the content of SO₃ is 0.2-1% by weight, and the content of P₂O₅ is 0.1-0.2% by weight.

The second aspect of the present invention provides a method for preparing a hydrogenated TiO₂ denitration catalyst, wherein the method comprises:

(1) contacting ilmenite with an acid for acidolysis to obtain an acidolysis solution;

(2) contacting the acidolysis solution with iron powder to reduce Fe³⁺ to Fe²⁺, and filtering the contact product:

(3) crystallizing the filtrate obtained in step (2) to obtain FeSO₄.7H₂O crystals and a titanium-containing solution;

(4) hydrolyzing the titanium-containing solution to obtain metatitanic acid colloid;

(5) calcining the metatitanic acid colloid to obtain TiO₂ powder;

(6) subjecting the TiO₂ powder to surface hydrogenation reduction to obtain a hydrogenated TiO₂ denitration catalyst.

The third aspect of the present invention provides a hydrogenated TiO₂ denitration catalyst prepared by the aforementioned method.

The fourth aspect of the present invention provides the use of the aforementioned TiO₂ denitration catalyst in NH₃—SCR denitration.

Through the abovementioned technical solution, the present invention has the following beneficial effects:

(1) The preparation method of the hydrogenated TiO₂ denitration catalyst of the present invention uses ilmenite as a raw material, and the utilization rate of the raw material is high, and the purpose of mineral resource utilization is achieved. In addition, the operation is simple and the cost is low.

(2) In the preparation method of the present invention, the impurities contained on the anatase TiO₂ prepared by the sulfuric acid method can be reasonably utilized to provide acid sites for the hydrogenated TiO₂, and to construct the defects of the TiO₂ crystal to reasonably control its redox properties.

(3) The hydrogenated TiO₂ denitration catalyst of the present invention can be used in flue gas denitration, which fills the blank of the hydrogenated TiO₂ material in the field of air pollutant treatment.

(4) The hydrogenated TiO₂ denitration catalyst of the present invention is a denitration catalyst without adding any active components.

### BRIEF DESCRIPTION OF THE DRAWINGS

FIG. 1 is a schematic diagram of the process flow of the preparation method of the hydrogenated TiO₂ denitration catalyst of the present invention;

FIG. 2 is a comparison diagram of the appearance of the hydrogenated TiO₂ denitration catalyst of the present invention and TiO₂ powder;

FIG. 3 is a comparison diagram of the X-ray diffraction of the hydrogenated TiO₂ denitration catalyst of the present invention and TiO₂ powder;

FIG. 4 is a comparison diagram of nitrogen adsorption-desorption isotherms of the hydrogenated TiO₂ denitration catalyst of the present invention;

FIG. 5 is a comparison diagram of ¹H NMR of the hydrogenated TiO₂ denitration catalyst of the present invention and TiO₂ powder;

FIG. 6 is a comparison diagram of the EPR of the hydrogenated TiO₂ denitration catalyst of the present invention and TiO₂ powder;

FIG. 7 is a TEM image of the hydrogenated TiO₂ denitration catalyst of the present invention;

FIG. 8 is a graph showing the denitration activity of the hydrogenated TiO₂ denitration catalyst of the present invention;

FIG. 9 is a graph showing the N₂ selectivity of the hydrogenated TiO₂ denitration catalyst of the present invention.

### DESCRIPTION OF REFERENCE NUMERALS

“1” is the TiO₂ powder; “2” is the hydrogenated TiO₂ denitration catalyst.

### DETAILED DESCRIPTION OF THE INVENTION

The endpoints of the ranges disclosed herein and any values are not limited to the precise ranges or values, which are to be understood to include values near those ranges or values. For ranges of values, the endpoints of each range, the endpoints of each range and the individual point values, and the individual point values can be combined with each other to yield one or more new ranges of values, and these ranges of values should be considered to be specifically disclosed herein.

The first aspect of the present invention provides a hydrogenated TiO₂ denitration catalyst, wherein the hydrogenated TiO₂ denitration catalyst has a crystal form of anatase form, with oxygen vacancies and surface hydroxyl groups, and the hydrogenated TiO₂ denitration catalyst contains TiO₂, SO₃ and P₂O₅, and based on the total weight of the hydrogenated TiO₂ denitration catalyst, the content of TiO₂ is 98-99.8% by weight, the content of SO₃ is 0.2-1% by weight, and the content of P₂O₅ is 0.1-0.2% by weight.

According to the present invention, the surface hydroxyl group is a hydroxyl group connected to Ti, and in the present invention, it is represented as Ti—OH.

According to the present invention, preferably, based on the total weight of the hydrogenated TiO₂ denitration catalyst, the content of TiO₂ is 98.5-99% by weight, the content of SO₃ is 0.25-0.3% by weight, and the content of P₂O₅ is 0.15-0.19% by weight.

According to the present invention, the hydrogenated TiO₂ denitration catalyst has a specific surface area of 100-150 m²/g, a pore volume of 0.35-0.45 cm³/g, and a pore diameter of 15-20 nm.

According to the present invention, preferably, the hydrogenated TiO₂ denitration catalyst has a specific surface area of 110-130 m²/g, a pore volume of 0.38-0.40 cm³/g, and a pore diameter of 16-18 nm.

According to the present invention, the hydrogenated TiO₂ denitration catalyst is black and has a ribbon-shaped appearance.

The second aspect of the present invention provides a method for preparing a hydrogenated TiO₂ denitration catalyst, wherein the method comprises:

(1) contacting ilmenite with an acid for acidolysis to obtain an acidolysis solution:

(2) contacting the acidolysis solution with iron powder to reduce Fe³⁺ to Fe²⁺, and filtering the contact product;

(3) crystallizing the filtrate obtained in step (2) to obtain FeSO₄.7H₂O crystals and a titanium-containing solution;

(4) hydrolyzing the titanium-containing solution to obtain metatitanic acid colloid;

(5) calcining the metatitanic acid colloid to obtain TiO₂ powder;

(6) subjecting the TiO₂ powder to surface hydrogenation reduction to obtain a hydrogenated TiO₂ denitration catalyst.

According to the present invention, in step (1), the acid is concentrated sulfuric acid; preferably, the concentration of the acid is 8-20 mol/L, preferably 12-15 mol/L, more preferably 13.5 mol/L.

According to the present invention, in step (1), the ilmenite comes from Panzhihua, Sichuan Province, wherein the main components of the ilmenite are Al₂O₃, SiO₂, TiO₂, Fe₂O₃, FeO, K₂O, CaO, MnO, MgO and other components. In the present invention, the ilmenite and the concentrated sulfuric acid are added into a three-necked flask at a mass ratio of 10:(11-16) and mixed, and then digesting for 1-5 h at a temperature of 120-160° C. to obtain an acidolysis solution; preferably, when the mass ratio of the amount of the ilmenite to the acid is 10:(11.76-15.68), the acidolysis effect is better.

According to the present invention, in step (2), in order to separate titanium and iron in the titanium solution and avoid the influence of the existence of iron ions on the color purity of product TiO₂, Fe³⁺ must be completely reduced to Fe²⁺, that is, the reducing agent iron powder is added to the acidolysis solution in step (1), wherein, the mass ratio of the amount of the ilmenite to the iron powder is 10:(0.2-2), preferably 10:(0.3-0.35). The conditions of the contact include: the temperature may be 120-160° C., and the time can be 15-30 min; preferably, the contact is performed under the conditions that the temperature is 120-140° C. and the time is 20-25 min, and the effect is better. Then, the heating is stopped, cooled to normal temperature, suction filtered, and the filter residue is filtered off to obtain a filtrate, wherein the main component of the filtrate is a mixture of TiOSO₄ and Ti(SO₄)₂.

Wherein, the reaction relationship is shown in formula (1):

2Fe³⁺+Fe→3Fe²⁺; formula (1).

According to the present invention, in step (3), the conditions of the crystallization include: the temperature is 0-6° C., and the time is 48-72 h; preferably, the crystallization treatment is carried out under the conditions that the temperature is 2-6° C. and the time is 48-56 h, and the effect is better. In the present invention, the crystallization may be performed in a refrigerator, and after crystallization, suction filtration is performed to obtain FeSO₄.7H₂O crystals, which are sealed and stored, and a titanium-containing solution, wherein the main component of the titanium-containing solution is Ti(SO₄)₂.

According to the present invention, in step (4), the solution containing Ti(SO₄)₂ is hydrolyzed, wherein the conditions of the hydrolysis include: the temperature may be 65-95° C., and the hydrolysis time may be 60-120 min; preferably, the conditions of the hydrolysis include: the temperature is 70-90° C., and the time is 80-100 min. More preferably, step (4) further comprises performing an aging treatment after hydrolysis, wherein, the conditions of the aging include: the temperature is 70-90° C., and the aging time is 6-12 h, and the effect is better. Then, the aged solution was separated by suction filtration, and washed with water to obtain metatitanic acid colloid.

According to the present invention, in step (5), the conditions of the calcination may include: the calcination temperature is 450-700° C., the calcination time is 2-8 h, and the heating rate is 5-10° C./min; preferably, the calcination is carried out for 5-6 h under the conditions that the temperature is 500-600° C. and the heating rate is 5-7° C./min, and the effect is better. In the present invention, the calcination may be performed in a muffle furnace. In step (5), the crystal form of the TiO₂ powder is anatase form.

Preferably, the TiO₂ powder contains TiO₂, SO₃ and P₂O₅, and based on the total weight of the TiO₂ powder, the content of TiO₂ is 94-96% by weight, the content of SO₃ is 5-7% by weight, and the content of P₂O₅ is 0.1-0.2% by weight. In the present invention, it should be noted that, in step (5), the surface hydrogenation reduction of the TiO₂ powder is performed, after hydrogenation, a part of SO₃ reacts with hydrogen, so that the percentage of SO₃ in the final obtained hydrogenated TiO₂ denitration catalyst decreases, and of course, the percentage of TiO₂ increases.

According to the present invention, in step (6), the conditions of the surface hydrogenation reduction include hydrogenation at a temperature of 400-500° C. under normal pressure and a 100% H₂ atmosphere, and a hydrogen flow rate of 100-300 mL/min, a hydrogenation time of 2-12 h. Preferably, the hydrogenation is performed at a temperature of 420-460° C. for 2-4 h, and the hydrogen flow rate is 100-150 mL/min, and the effect is better.

According to a preferred embodiment of the present invention, the method comprises:

(1) first, adding ilmenite and concentrated sulfuric acid into a three-necked flask, and stirring and reacting at 120-160° C. for 1 h to obtain a mixture;

(2) then, adding iron powder to the above mixture and reacting for 15-30 min; stopping heating, cooling to room temperature, and suction filtering to obtain a filtrate;

(3) next, placing the filtrate in a refrigerator at 0-6° C. for crystallization for two days, and suction filtering to obtain FeSO₄.7H₂O crystals, which are sealed and stored. The main component of the filtrate is TiOSO₄, denoted as A solution;

(4) after that, hydrolyzing the A solution, ageing, separating by suction filtration, and washing with water to obtain metatitanic acid colloid;

(5) then, drying the metatitanate colloid at 80-100° C. for 8 h, and finally calcining in a muffle furnace to obtain TiO₂ powder;

(6) finally, performing surface hydrogenation reduction on the anatase TiO₂ powder to obtain a hydrogenated TiO₂ powder.

The third aspect of the present invention provides a hydrogenated TiO₂ denitration catalyst prepared by the aforementioned method.

The fourth aspect of the present invention provides the use of the aforementioned hydrogenated TiO₂ denitration catalyst in NH₃—SCR denitration.

According to the present invention, specifically, the use comprises contacting industrial waste gas containing nitrogen oxides and a mixed gas containing ammonia, oxygen and nitrogen with the aforementioned hydrogenated TiO₂ denitration catalyst for denitration reaction.

According to the invention, the use is carried out at a temperature of 100-400° C.

According to the present invention, the volume concentration of the nitrogen oxides measured in NO may be 100-1000 ppm.

According to the present invention, based on the total volume of the mixed gas, the amount of oxygen may be 3-5% by volume, and the amount of nitrogen may be 95-97% by volume.

According to the present invention, the molar ratio of ammonia to the nitrogen oxide measured in NO is (1-3):1.

According to the present invention, the volume space velocity of the total feed rate of the industrial waste gas and ammonia is 3000-150000 h⁻¹.

The present invention will be described in detail by embodiments below.

In the following Examples and Comparative Examples:

(1) The crystal structure of the prepared hydrogenated TiO₂ denitration catalyst was measured by XRD analysis, using D8 ADVANCE from Bruker, Germany. and the test scanning rate was 0.5°/min to 5°/min;

(2) The pore structure and mesopore pore diameter of the prepared hydrogenated TiO₂ denitration catalyst were determined by the N₂ adsorption method, using the ASAP 2020 physical adsorption instrument from Micromeritics Company, USA, and the adsorption medium was N₂;

(3) The morphology of the prepared hydrogenated TiO₂ denitration catalyst was measured by TEM, using a JEM ARM 200F transmission electron microscope from JEOL Corporation, Japan.

### Example 1

This example is to illustrate the hydrogenated TiO₂ denitration catalyst prepared by the method of the present invention.

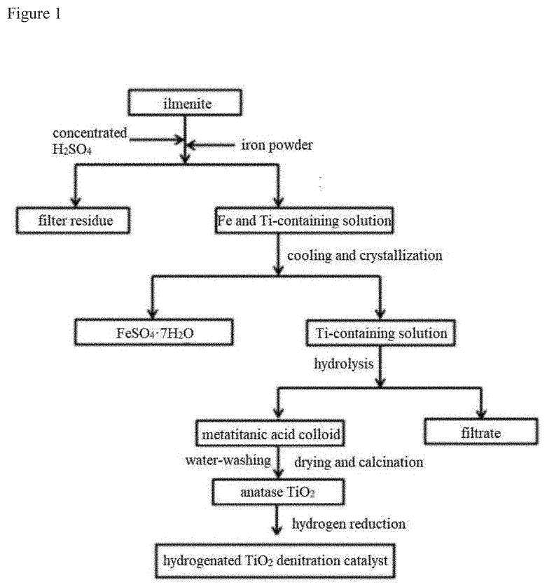

As shown in FIG. 1.

(1) Ilmenite and concentrated sulfuric acid (13.5 mol/L) were mixed at a mass ratio of ilmenite to concentrated sulfuric acid of 10:11.76, after mixing, reacted at 120° C. for 5 h to obtain an acidolysis solution; wherein the chemical composition analysis results (in w_{B}%) of the ilmenite are shown in Table 1.

TABLE 1

| | | | | | | | | | | Other |
|---|---|---|---|---|---|---|---|---|---|---|
| | Al₂O₃ | SiO₂ | TiO₂ | Fe₂O₃ | FeO | K₂O | CaO | MnO | MgO | impurities |
| Ilmenite, % by weight | 1.23 | 4.68 | 44.6 | 3.05 | 35.75 | 0.134 | 1.06 | 0.64 | 4.52 | 4.336 |

(2) Then, iron powder was added to the above acidolysis solution, and the iron powder was added at a mass ratio of ilmenite to iron powder of 10:0.3, and reacted for 15 min. Removed from heating, cooled to normal temperature, and the filtrate was obtained by suction filtration.

(3) Next, the filtrate was placed in a refrigerator at 0-6° C. for crystallization for 72 h, and suction filtered, wherein, FeSO₄.7H₂O crystals, which were sealed and stored, were obtained, and a filtrate containing Ti(SO₄)₂ was also obtained.

(4) After that, the filtrate was hydrolyzed at 65° C. for 2 h, then aged at 70° C. for 12 h, separated by suction filtration, and washed with water to obtain metatitanic acid colloid.

(5) Then, the metatitanate colloid was dried at 80° C. for 8 h, and finally calcined at 450° C. for 8 h at a heating rate of 10° C./min in a muffle furnace to obtain TiO₂ powder.

(6) Finally, the anatase TiO₂ powder was subjected to surface hydrogenation reduction, under normal pressure and 100% H₂ atmosphere, hydrogenated at 400° C. in a tube furnace, kept for 12 h, and then cooled to room temperature.

As a result, a hydrogenated TiO₂ denitration catalyst was obtained. The hydrogenated TiO₂ denitration catalyst has the crystal form of anatase form, with oxygen vacancies and surface hydroxyl groups; and based on the total weight of the hydrogenated TiO₂ denitration catalyst, the content of TiO₂, the content of SO₃, the content of P₂O₅, and the parameters of the hydrogenated TiO₂ denitration catalyst are shown in Table 2.

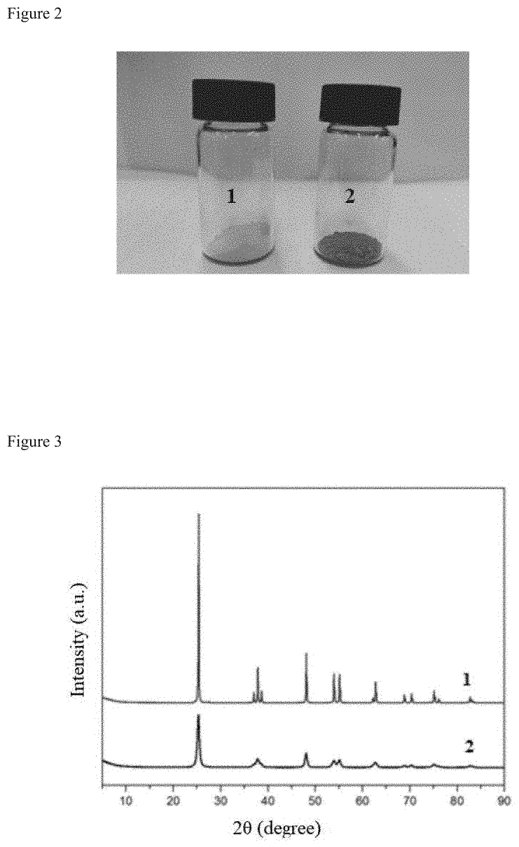

FIG. 2 is a comparison diagram of the appearance of the hydrogenated TiO₂ denitration catalyst of the present invention and TiO₂ powder; it can be seen from the diagram that the TiO₂ powder is a white powder, while the hydrogenated TiO₂ denitration catalyst of the present invention is a dark brown powder.

FIG. 3 is a comparison diagram of the X-ray diffraction of the hydrogenated TiO₂ denitration catalyst of the present invention and TiO₂ powder; wherein, 1 represents the diffraction peak of the TiO₂ powder, and 2 represents the diffraction peak of the hydrogenated TiO₂ denitration catalyst of the present invention. As can be seen from FIG. 3, all the diffraction peaks of the hydrogenated TiO₂ denitration catalyst of the present invention are consistent with the diffraction peaks of the TiO₂ powder, and no impurities appear, this result is consistent with the XRD spectrum of the mesoporous TiO₂ reported in the literature; in addition, the XRD diffraction peaks of the hydrogenated TiO₂ denitration catalyst were significantly broadened and lower, indicating that the size and structure of the crystallites have changed slightly, which was due to the generation of trivalent titanium and oxygen vacancies during the hydrogenation reduction process.

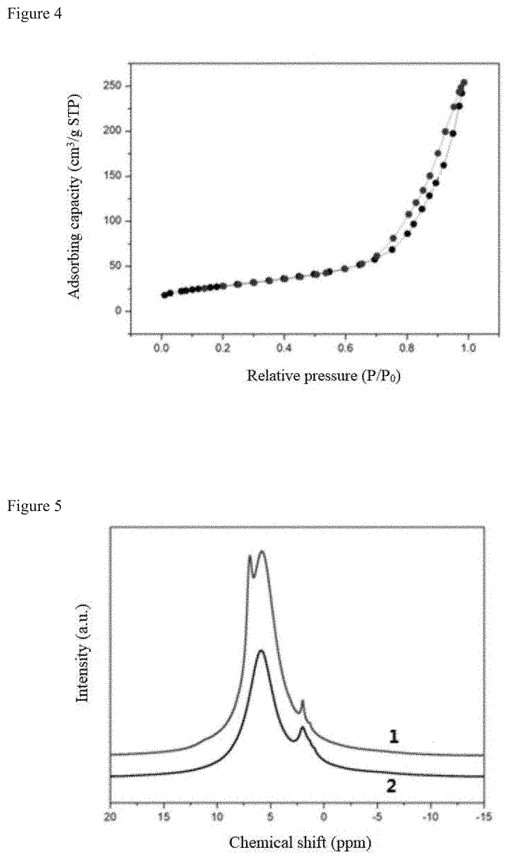

FIG. 4 is a comparison diagram of nitrogen adsorption-desorption isotherms of the hydrogenated TiO₂ denitration catalyst of the present invention; wherein, one of the two curves is an adsorption curve and the other is a desorption curve. FIG. 4 shows that the hydrogenated TiO₂ denitration catalyst of the present invention is of Langmuir IV form, which belongs to the typical adsorption curve of mesoporous substances, that is, with the increase of adsorption partial pressure, a large hysteresis loop appeared. In addition, the relative pressure p/p₀ value corresponding to the steep increase point of the adsorbing capacity in the adsorption isotherm indicates the pore size of the sample. As can be seen from the pore size distribution diagram in FIG. 3, the hydrogenated TiO₂ denitration catalyst of the present invention has a highly ordered mesoporous structure, uniform pore size distribution and regular pore channels.

FIG. 5 is a comparison diagram of ¹H NMR of the hydrogenated TiO₂ denitration catalyst of the present invention and TiO₂ powder; as can be seen from the figure, wherein, 1 represents the TiO₂ powder, and 2 represents the hydrogenated TiO₂ denitration catalyst of the present invention; at 5-7 ppm is the water adsorbed on the surface, at 2 ppm is the H—O_{3C} functional group on the surface of TiO₂. As can be seen from FIG. 5, the curve represented by 2 is after hydrogenation, after hydrogenation, the content of the water adsorbed on the surface was significantly reduced, and the content of H—O_{3C} functional groups on the surface was significantly increased, which was related to the existence of hydrogen in the disordered surface layer caused by hydrogenation.

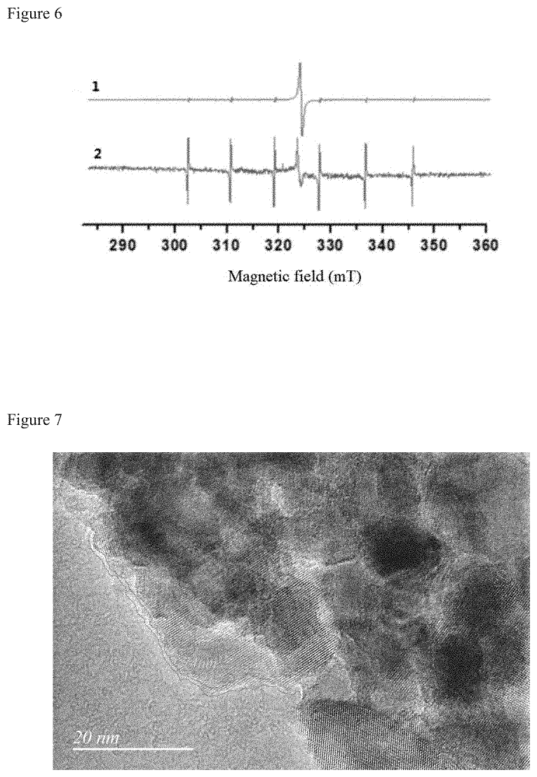

FIG. 6 is a comparison diagram of the EPR of the hydrogenated TiO₂ denitration catalyst of the present invention and TiO₂ powder; the signal peak at 320-325 mT is the signal peak of oxygen vacancy (V_{O}*)Ti³⁺. As can be seen from FIG. 6, 1 represents the TiO₂ powder, 2 represents the hydrogenated TiO₂ denitration catalyst of the invention. After hydrogenation, more signal peaks of (V_{O}*)Ti³⁺ were generated, indicating that hydrogenation resulted in more oxygen vacancies on the surface of the material, which was more conducive to the denitration reaction.

FIG. 7 is a TEM image of the hydrogenated TiO₂ denitration catalyst of the present invention. As can be seen from FIG. 7, the edge of the TiO₂ crystal nucleus seemed to be etched, forming a thin layer of disordered layer, which further indicated that TiO2 was successfully hydrogenated.

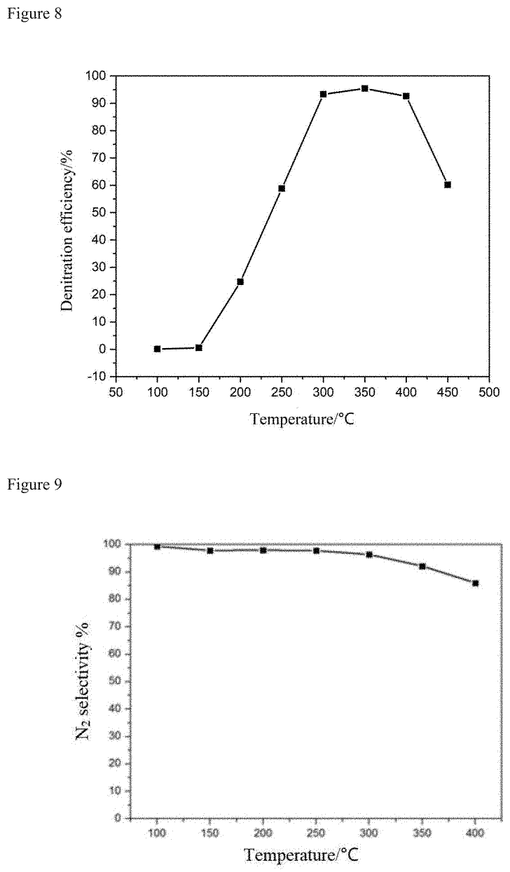

FIG. 8 is a graph showing the denitration activity of the hydrogenated TiO₂ denitration catalyst of the present invention; as can be seen from FIG. 8, at 300-400° C., the denitration activity of the hydrogenated TiO₂ was >90%. It indicates that the hydrogenated TiO₂ can be used in the field of medium and high temperature denitration.

FIG. 9 is a graph showing the N₂ selectivity of the hydrogenated TiO₂ denitration catalyst of the present invention. As can be seen from FIG. 9, at 100-400° C., the N₂ selectivity was >85%, indicating that the hydrogenated TiO₂ has good N selectivity as a denitration catalyst.

### Example 2

This example is to illustrate the hydrogenated TiO₂ denitration catalyst prepared by the method of the present invention.

(1) Ilmenite and concentrated sulfuric acid (13.5 mol/L) were mixed at a mass ratio of ilmenite to concentrated sulfuric acid of 10:15.68, after mixing, reacted at 160° C. for 1 h to obtain an acidolysis solution; wherein the chemical composition analysis results (in w_{B}%) of the ilmenite are shown in Table 1.

(2) Then, iron powder was added to the above acidolysis solution, and the iron powder was added at a mass ratio of ilmenite to iron powder of 10:0.35, and reacted for 30 min. Removed from heating, cooled to normal temperature, and the filtrate was obtained by suction filtration.

(3) Next, the filtrate was placed in a refrigerator at 6° C. for crystallization for 48 h, and suction filtered, wherein. FeSO₄.7H₂O crystals, which were sealed and stored, were obtained, and a filtrate containing Ti(SO₄)₂ was also obtained.

(4) After that, the filtrate was hydrolyzed at 95° C. for 1 h, aged at 90° C. for 6 h, separated by suction filtration, and washed with water to obtain metatitanic acid colloid.

(5) Then, the metatitanate colloid was dried at 80° C. for 8 h, and finally calcined at 700° C. for 2 h at a heating rate of 5° C./min in a muffle furnace to obtain TiO₂ powder.

(6) Finally, the anatase TiO₂ powder was subjected to surface hydrogenation reduction, under normal pressure and 100% H₂ atmosphere, hydrogenated at 500° C. in a tube furnace, kept for 2 h, and then cooled to room temperature.

As a result, a hydrogenated TiO₂ denitration catalyst was obtained. The hydrogenated TiO₂ denitration catalyst has the crystal form of anatase form, with oxygen vacancies and surface hydroxyl groups; and based on the total weight of the hydrogenated TiO₂ denitration catalyst, the content of TiO₂, the content of SO₃, the content of P₂O₅, and the parameters of the hydrogenated TiO₂ denitration catalyst are shown in Table 2.

### Example 3

This example is to illustrate the hydrogenated TiO₂ denitration catalyst prepared by the method of the present invention.

(1) Ilmenite and concentrated sulfuric acid (13.5 mol/L) were mixed at a mass ratio of ilmenite to concentrated sulfuric acid of 10:13, after mixing, reacted at 140° C. for 3 h to obtain an acidolysis solution; wherein the chemical composition analysis results (in w_{B}%) of the ilmenite are shown in Table 1.

(2) Then, iron powder was added to the above acidolysis solution, and the iron powder was added at a mass ratio of ilmenite to iron powder of 10:0.32, and reacted for 20 min. Removed from heating, cooled to normal temperature, and the filtrate was obtained by suction filtration.

(3) Next, the filtrate was placed in a refrigerator at 4° C. for crystallization for 50 h, and suction filtered, wherein, FeSO₄ 7H₂O crystals, which were sealed and stored, were obtained, and a filtrate containing Ti(SO₄)₂ was also obtained.

(4) After that, the filtrate was hydrolyzed at 80° C. for 10 min, aged at 80° C. for 10 h. separated by suction filtration, and washed with water to obtain metatitanic acid colloid.

(5) Then, the metatitanate colloid was dried at 80° C. for 8 h, and finally calcined at 600° C. for 5 h at a heating rate of 8° C./min in a muffle furnace to obtain TiO₂ powder.

(6) Finally, the anatase TiO₂ powder was subjected to surface hydrogenation reduction, under normal pressure and 100% H₂ atmosphere, hydrogenated at 450° C. in a tube furnace, kept for 6 h, and then cooled to room temperature.

As a result, a hydrogenated TiO₂ denitration catalyst was obtained. The hydrogenated TiO₂ denitration catalyst has the crystal form of anatase form, with oxygen vacancies and surface hydroxyl groups Ti—OH; and based on the total weight of the hydrogenated TiO₂ denitration catalyst, the content of TiO₂, the content of SO₃, the content of P₂O₅, and the parameters of the hydrogenated TiO₂ denitration catalyst are shown in Table 2.

### Example 4

This example is to illustrate the hydrogenated TiO₂ denitration catalyst prepared by the method of the present invention.

The hydrogenated TiO₂ denitration catalyst was prepared in the same way as in Example 1, except that:

in step (1), ilmenite and concentrated sulfuric acid (13.5 mol/L) were mixed at a mass ratio of ilmenite to concentrated sulfuric acid of 10:11, and reacted at 150° C. for 2 h; and

in step (2), iron powder was added at a mass ratio of ilmenite to iron powder of 10:0.2, and reacted for 20 min.

As a result, a hydrogenated TiO₂ denitration catalyst was obtained. The hydrogenated TiO₂ denitration catalyst has the crystal form of anatase form, with oxygen vacancies and surface hydroxyl groups Ti—OH; and based on the total weight of the hydrogenated TiO₂ denitration catalyst, the content of TiO₂, the content of SO₃, the content of P₂O₅, and the parameters of the hydrogenated TiO₂ denitration catalyst are shown in Table 2.

### Example 5

This example is to illustrate the hydrogenated TiO₂ denitration catalyst prepared by the method of the present invention.

The hydrogenated TiO₂ denitration catalyst was prepared in the same way as in Example 1, except that:

in step (1), ilmenite and concentrated sulfuric acid (13.5 mol/L) were mixed at a mass ratio of ilmenite to concentrated sulfuric acid of 10:16, and reacted at 120° C. for 4 h; and

in step (2), iron powder was added at a mass ratio of ilmenite to iron powder of 10:2, and reacted for 25 min.

As a result, a hydrogenated TiO₂ denitration catalyst was obtained. The hydrogenated TiO₂ denitration catalyst has the crystal form of anatase form, with oxygen vacancies and surface hydroxyl groups Ti—OH; and based on the total weight of the hydrogenated TiO₂ denitration catalyst, the content of TiO₂, the content of SO₃, the content of P₂O₅, and the parameters of the hydrogenated TiO₂ denitration catalyst are shown in Table 2.

### Comparative Example 1

Commercially purchased TiO₂ was used, and the parameters of the catalyst are shown in Table 2.

### Comparative Example 2

A hydrogenated TiO₂ denitration catalyst was prepared in the same way as in Example 2, except that: in step (6), the conditions for the surface hydrogenation reduction included hydrogenation at a temperature of 450° C. under normal pressure and a 5% H₂/95% N₂ atmosphere, and a hydrogen flow rate of 5100 mL/min, a hydrogenation time of 10 h.

As a result, a catalyst was obtained, and the parameters of the catalyst are shown in Table 2.

### Comparative Example 3

The hydrogenated TiO₂ denitration catalyst was prepared in the same way as in Example 2, except that: in step (6), the conditions for the surface hydrogenation reduction included hydrogenation at a temperature of 300° C. under normal pressure and a 100% H₂ atmosphere, and a hydrogen flow rate of 50 mL/min, a hydrogenation time of 15 h.

As a result, a catalyst was obtained, and the parameters of the catalyst are shown in Table 2.

TABLE 2

| | Specific | | | | | |
|---|---|---|---|---|---|---|
| | surface | Pore | Pore | TiO₂ | SO₃ | P₂O₅ |
| | area | volume | diameter | content | content | content |
| Number | (m²/g) | (cm³/g) | (nm) | (wt %) | (wt %) | (wt %) |
| Example 1 | 112 | 0.39 | 15.2 | 99.42 | 0.4 | 0.12 |
| Example 2 | 148 | 0.44 | 18.4 | 98.76 | 1 | 0.2 |
| Example 3 | 134 | 0.41 | 17.7 | 99.00 | 0.8 | 0.18 |
| Example 4 | 110 | 0.38 | 15.0 | 98.37 | 0.38 | 0.11 |
| Example 5 | 113 | 0.40 | 15.3 | 99.40 | 0.42 | 0.10 |
| Comparative | 70 | 0.27 | 5.2 | 100 | — | — |
| Example 1 | | | | | | |
| Comparative | 148 | 0.44 | 18.4 | 99.35 | 0.43 | 0.18 |
| Example 2 | | | | | | |
| Comparative | 89 | 0.30 | 14.3 | 98.6 | 1.05 | 0.25 |
| Example 3 | | | | | | |

As can be seen from the results in Table 2, in Comparative Example 1, TiO₂ without impurities was used for hydrogenation; in Comparative Example 2, hydrogen with low concentration was used for hydrogenation; and in Comparative Example 3, hydrogenation was carried out under the conditions that the hydrogenation time and hydrogenation temperature were not within the scope of the present invention. As a result, Examples 1-5 using the hydrogenated TiO₂ denitration catalyst of the present invention had high specific surface area, and the content of TiO₂, SO₃ and P₂O₅ were all within the scope defined by the present invention.

### Application Example

The catalysts prepared in Examples 1-5 and Comparative Examples 1-3 were used in NH₃—SCR denitration, wherein the industrial waste gas containing nitrogen oxides and the mixed gas containing ammonia, oxygen and nitrogen were respectively contacted with the low-temperature denitration catalysts prepared in Examples 1-5 of the present invention and Comparative Examples 1-3, at temperatures of 100° C. 200° C., 250° C., 300° C. and 350° C. respectively, for denitration reaction. In the industrial waste gas, the volume concentration of nitrogen oxides measured in NO was 500 ppm, the oxygen content in the mixture was 4% by volume, and the molar ratio of ammonia to the nitrogen oxides measured in NO in the industrial waste gas was 2:1; the volume space velocity of the total feed rate of the industrial waste gas and ammonia gas atmosphere was 100000 h⁻¹. The results are shown in Tables 3 and 4.

TABLE 3

| | Denitration efficiency (%) | | | | | | | |
|---|---|---|---|---|---|---|---|---|
| | 100° C. | 150° C. | 200° C. | 250° C. | 300° C. | 350° C. | 400° C. | 450° C. |
| Example 1 | 0 | 0.33 | 19.8 | 54.6 | 90.4 | 90.3 | 91.1 | 55.7 |
| Example 2 | 0.13 | 0.52 | 24.7 | 58.8 | 93.3 | 95.4 | 92.6 | 60.2 |
| Example 3 | 0.12 | 0.48 | 23.3 | 55.4 | 92.8 | 94.2 | 91.0 | 58.7 |
| Example 4 | 0.02 | 0.28 | 18.5 | 48.3 | 90.0 | 90.2 | 90.4 | 51.4 |
| Example 5 | 0.10 | 0.50 | 24.1 | 50.7 | 90.8 | 90.6 | 90.5 | 52.3 |
| Comparative | 0 | 0 | 0 | 0 | 0 | 0 | 0 | 0 |
| Example 1 | | | | | | | | |
| Comparative | 0.05 | 0.33 | 19.9 | 49.0 | 74.2 | 65.7 | 70.1 | 48.3 |
| Example 2 | | | | | | | | |
| Comparative | 0 | 0.12 | 24.6 | 46.8 | 68.4 | 71.3 | 73.4 | 44.0 |
| Example 3 | | | | | | | | |

TABLE 4

| | N₂ selectivity (%) | | | | | | | |
|---|---|---|---|---|---|---|---|---|
| | 100° C. | 150° C. | 200° C. | 250° C. | 300° C. | 350° C. | 400° C. | 450° C. |
| Example 1 | 99.0 | 96.6 | 97.5 | 95.6 | 94.7 | 93.3 | 85.2 | 72.0 |
| Example 2 | 99.3 | 97.2 | 98.0 | 97.8 | 96.7 | 92.4 | 85.4 | 76.8 |
| Example 3 | 98.8 | 96.8 | 97.7 | 96.3 | 95.1 | 90.7 | 85.0 | 74.5 |
| Example 4 | 99.2 | 97.0 | 96.3 | 96.0 | 94.4 | 91.7 | 85.1 | 75.4 |
| Example 5 | 98.9 | 97.2 | 96.6 | 95.8 | 93.1 | 90.2 | 85.0 | 73.1 |
| Comparative | — | — | — | — | — | — | — | — |
| Example 1 | | | | | | | | |
| Comparative | 95.2 | 96.1 | 93.4 | 94.7 | 92.8 | 91.5 | 80.2 | 64.0 |
| Example 2 | | | | | | | | |
| Comparative | 96.4 | 96.8 | 94.2 | 95.5 | 93.7 | 92 7 | 77.6 | 62.8 |
| Example 3 | | | | | | | | |

As can be seen from the results in Table 3 and Table 4, when the hydrogenated TiO₂ denitration catalysts prepared in Examples 1-5 of the present invention were used in NH₃—SCR denitration, the catalysts could remove 90% of the NOₓ, concentration in the gas at 300-400° C., no by-product N₂O was produced, and the N₂ selectivity was as high as 85% or more. However, when the catalysts prepared in Comparative Example 1-3 was used in NH₃—SCR denitration, the catalysts could remove only 60-75% of NOₓ concentration in the gas at 300-400° C., and the N₂ selectivity was slightly worse than that of Example 1-5.

The preferred embodiments of the present invention have been described above in detail, however, the present invention is not limited thereto. Within the scope of the technical concept of the present invention, a variety of simple modifications can be made to the technical solutions of the present invention, including combining various technical features in any other suitable manner. These simple modifications and combinations should also be regarded as the content disclosed in the present invention, and all belong to the protection scope of the present invention.

1. A hydrogenated TiO₂ denitration catalyst, wherein the hydrogenated TiO₂ denitration catalyst has a crystal form of anatase form, with oxygen vacancies and surface hydroxyl groups; wherein the hydrogenated TiO₂ denitration catalyst contains TiO₂, SO₃ and P₂O₅, and based on the total weight of the hydrogenated TiO₂ denitration catalyst, the content of TiO₂ is 98-99.8% by weight, the content of SO₃ is 0.2-1% by weight, and the content of P₂O₅ is 0.1-0.2% by weight.

2. The catalyst according to claim 1, wherein the hydrogenated TiO₂ denitration catalyst has a specific surface area of 100-150 m²/g, a pore volume of 0.35-0.45 cm³/g, and a pore diameter of 15-20 nm.

3. A method for preparing a hydrogenated TiO₂ denitration catalyst, wherein the method comprises:
(1) contacting ilmenite with an acid for acidolysis to obtain an acidolysis solution;
(2) contacting the acidolysis solution with iron powder to reduce Fe³⁺ to Fe²⁺, and filtering the contact product;
(3) crystallizing the filtrate obtained in step (2) to obtain FeSO₄.7H₂O crystals and a titanium-containing solution;
(4) hydrolyzing the titanium-containing solution to obtain metatitanic acid colloid;
(5) calcining the metatitanic acid colloid to obtain TiO₂ powder;
(6) subjecting the TiO₂ powder to surface hydrogenation reduction to obtain a hydrogenated TiO₂ denitration catalyst.

4. The method according to claim 3, wherein, in step (1), the acid is concentrated sulfuric acid.

5. The method according to claim 3, wherein, in step (2), the conditions of the contact include: the temperature is 120-160° C., and the time is 15-30 min.

6. The method according to claim 3, wherein, in step (3), the conditions of the crystallization include: the temperature is 0-6° C., and the time is 48-72 h.

7. The method according to claim 3, wherein, in step (4), the hydrolysis conditions include: the temperature is 65-95° C., and the hydrolysis time is 60-120 min.

8. The method according to claim 3, wherein, in step (5), the conditions of the calcination include: the calcination temperature is 450-700° C., the calcination time is 2-8 h, and the heating rate is 5-10° C./min.

9. The method according to claim 3, wherein, in step (6), the conditions for the surface hydrogenation reduction include hydrogenation at a temperature of 400-500° C. under normal pressure and a 100% H₂ atmosphere, and a hydrogen flow rate of 100-300 mL/min, a hydrogenation time of 2-12 h.

10. (canceled)

11. Use of the hydrogenated TiO₂ denitration catalyst according to claim 1 in NH₃—SCR denitration.

12. The method according to claim 4, wherein, in step (1), the concentration of the acid is 8-20 mol/L.

13. The method according to claim 4, wherein, in step (1), the conditions of acidolysis include: the temperature is 120-160° C., and the time is 1-5 h.

14. The method according to claim 4, wherein, in step (1), the mass ratio of the amount of the ilmenite to the acid is 10:(11-16).

15. The method according to claim 5, wherein, in step (2), the mass ratio of the amount of the ilmenite to the iron powder is 10:(0.2-2).

16. The method according to claim 7, wherein, step (4) further comprises performing an aging treatment after hydrolysis, wherein, the conditions of the aging include: the temperature is 70-90° C., and the aging time is 6-12 h.

17. The method according to claim 8, wherein, in step (5), the crystal form of the TiO₂ powder is anatase form.

18. The catalyst according to claim 2, wherein the hydrogenated TiO₂ denitration catalyst has a specific surface area of 110-130 m²/g, a pore volume of 0.38-0.40 cm³/g, and a pore diameter of 16-18 nm.

19. The catalyst according to claim 1, wherein the hydrogenated TiO₂ denitration catalyst has a ribbon-shaped appearance.
